(19) United States
(12) Patent Application Publication
(10) Pub. No.: US 2015/0128759 A1
(43) Pub. Date: May 14, 2015

(54) SERIES OF GEAR TRAIN HOUSINGS

(71) Applicant: Siemens Aktiengesellschaft, München (DE)

(72) Inventors: Wolfgang Schnurr, Nehren (DE); Robert Stoll, Tubingen (DE)

(21) Appl. No.: 14/395,317

(22) PCT Filed: Apr. 10, 2013
(86) PCT No.: PCT/EP2013/057426

§ 371 Date: Oct. 17, 2014

(30) Foreign Application Priority Data
Apr. 18, 2012 (EP) 12164624.4

(51) Int. Cl. F16H 57/033

(52) U.S. Cl. CPC F16H 57/033; F16H 2057/02034
USPC 74/606 R

(57) ABSTRACT

A series of gear train housings has different sizes. Each size includes a series of different housing types, which are suitable for at least two different gear train types of the following types: spur-gear gear trains, bevel-gear gear trains, flat gear trains, and worm gear trains. Each gear train housing has a housing opening on the drive side, which housing opening is surrounded by a drive flange for connecting a motor, an adapter plate, or an additional gear train. In at least two different sizes, the axes of bearing points designed to accommodate shaft bearings for toothed parts, said axes extending perpendicularly to the plane of the drive flange, lie inside a minimum inside diameter of the drive flange as viewed in a direction perpendicular to the plane of the drive flange for at least two different types of each of said sizes.

The present invention relates to a series of gear train housings.

To achieve low-cost storage and assembly, it is desirable to equip the different gear trains of a gear train series with the most universal interface possible for attaching a motor, adapter plate or additional gear train.

The object of the present invention is to disclose a series of gear train housings that have an improved interface for attaching a motor, adapter plate or additional gear train.

This object is achieved according to the invention by a series of gear train housings with the features disclosed in claim 1.

The inventive series of gear train housings comprises different sizes. Each size comprises a family of different housing types. The housing types are suitable for at least two different gear train types of the following types: spur-gear gear trains, bevel-gear gear trains, flat gear trains, and worm gear trains. Each gear train housing has a housing opening on the drive side. The housing opening is surrounded by a drive flange to connect a motor, adapter plate, or additional gear train. The axes of bearing points provided to accommodate shaft bearings for toothed parts, which axes run perpendicularly to the plane of the drive flange, lie inside a minimum internal diameter of the drive flange as viewed in a direction perpendicular to the plane of the drive flange for at least two different types respectively in at least two different sizes.

Different sizes are differentiated by the housing dimensions, which are determined in particular by the axis spacings of the first gear train stage and therefore by the performance design.

The drive flange is a drive-side connecting flange realized as a flat surface, to which a connecting flange of a motor, or of an additional gear train, or of an adapter plate is fixed, with a sealing agent, such as a sealing ring, usually being arranged between the two abutting flanges. A plane inserted in to this surface is referred to as the plane of the drive flange.

Bearing points are also called bearing supports. Each bearing support can be assigned an axis that coincides with an axis of a shaft bearing to be inserted in to the bearing support or a shaft mounted in the shaft bearing. The term “toothed parts” refers to all reciprocally engaging or reciprocally meshing components that are mounted so as to rotate, such as spur gears, bevel gears, pinions, and worm gears.

The invention is based on the finding that a considerable benefit and advantage in terms of storage, assembly, and maintenance of gear train housings and gear trains based on them, in particular industrial gear trains, is achieved if an interior space of the gear train housing, which accommodates toothed parts, is accessible in an optimum manner via the drive interface. Enlarging the housing opening to the maximum possible extent achieves the outcome that the axes of bearing points provided to accommodate shaft bearings for toothed parts, which axes run perpendicularly to the plane of the drive flange, lie inside a minimum internal diameter of the drive flange as viewed in a direction perpendicular to the plane of the drive flange. These aforesaid axes are therefore readily accessible, which assists simple and efficient assembly and maintenance, such as the adjustability of the bearings.

With regard to a bevel-gear gear train, this produces in particular the advantage that the axial bearing position of the shafts running perpendicularly to the plane of the drive flange inside the housing opening creates the possibility that the bearings of these shafts can be assembled from the motor side and adequate space is left for a cover seal. The bearing of the bevel pinion shaft can therefore likewise be assembled from the motor side and the drilled hole of the bevel pinion shaft bearing can be fabricated from the motor side.

The invention creates an interface on the gear train input side of modular gear trains for attaching different types of motors, such as asynchronous or servo motors, and adapters for incorporating IEC or NEMA motors, and also additional gear trains (IEC=International Electrotechnical Commission; NEMA=National Electrical Manufacturers Association). In particular, the invention creates a universal motor/gear train interface on a motor-side housing opening of a gear train housing.

Advantageous embodiments and developments of the invention are disclosed in the dependent claims.

According to a preferred embodiment of the invention, the axes of bearing points provided to accommodate shaft bearings for toothed parts, which axes run perpendicularly to the plane of the drive flange, lie inside the minimum internal diameter of the drive flange as viewed in a direction perpendicular to the plane of the drive flange for all types respectively in at least two different sizes. An advantage in this respect is the fact that the assembly and maintenance of shaft bearings, shafts, and toothed parts is considerably simplified by the easily accessible position inside the housing opening.

According to a preferred development of the invention, a ratio of a maximum external diameter of the drive flange to an axis spacing of bearing points provided to accommodate shaft bearings for toothed parts of a first gear train stage lies in a range from 2.74 to approx. 3.00 in all sizes in the case of a type suitable for a spur-gear gear train. An advantage in this respect is the fact that given this value range, the assembly and maintenance of shaft bearings, shafts, and toothed parts of a first gear train stage is considerably simplified by the easily accessible position inside the housing opening.

It is possible for a ratio of a minimum external diameter of the drive flange to a minimum internal diameter of the drive flange to lie in a range from 1.07 to 1.21 in all sizes in the case of a type suitable for a spur-gear gear train. An advantage in this respect is the fact that given this value range, the opening width of the accessible housing opening is optimized in terms of the existing dimensions of the housing so that the assembly and maintenance of shaft bearings, shafts, and toothed parts is considerably simplified by the easily accessible position inside the housing opening.

According to a preferred development of the invention, drilled holes are arranged in the drive flange, which drilled holes lie on a hole circle with a diameter and are provided to accommodate connecting screws, and wherein a ratio of a minimum external diameter of the drive flange to the diameter of the hole circle lies in a range from 0.97 to 1.05 in all sizes in the case of a type suitable for a spur-gear gear train. An advantage in this respect is the fact that given this value range, the connection circle together with its sealing function is realized in the most space-saving manner possible in terms of the existing dimensions of the housing so that the opening width of the accessible housing opening is maximized. The assembly and maintenance of shaft bearings, shafts, and toothed parts is thereby considerably simplified by the easily accessible position inside the housing aperture.

According to a preferred development of the invention, the drive flange is at least essentially circular, i.e. the inner and outer edges of the drive flange run at least essentially along an inner and outer circular line respectively. The at least essentially circular flange surface is realized between the inner and outer circular lines.

The following embodiments are encompassed by the restriction “at least essentially”: the outer edge of the drive flange can have a non-curved section, a so-called ‘flat’, in the 12 o'clock position and/or the 3 o'clock position and/or the 6 o'clock position and/or the 9 o'clock position respectively. It is also possible for the outer edge of the drive flange to have a section with a curvature that diverges from the circular part of the outer edge in the 6 o'clock position. Additionally, the inner edge of the drive flange can have a section with a curvature that diverges from the circular part of the inner edge in the 6 o'clock position.

Preferably, the drive flange has flats on two oppositely located sides, the distance between which flats defines the minimum external diameter of the drive flange. The flats cause the external diameter of the connecting flange to be reduced at the narrowest point of the housing so that the closing flange does not protrude beyond the housing.

According to a preferred development of the invention, the drive flange has drilled holes, which are arranged point-symmetrically on a hole circle with a hole circle diameter and are provided to accommodate connecting screws. The connecting screws connect the drive flange to a corresponding connecting flange of a motor or gear train.

According to a preferred embodiment of the invention, the hole circle runs uninterruptedly on the drive flange over its entire periphery. An uninterrupted connecting surface is thus created. The compressive force generated by the connecting screws can therefore be applied to a sealing agent, such as a sealing ring, without interruption so that reliable sealing of the drive flange is achieved.

According to a preferred embodiment of the invention, the essentially circular drive flange has flats on two oppositely located sides. In this respect, eight drilled holes are arranged in the drive flange, wherein four drilled holes are arranged in each half of the drive flange as divided by a distance line of the flats. “Distance line” is understood to mean a straight line running in the plane of the drive flange that coincides with the shortest connecting line between the oppositely located flats, that is to say coincides with a line that connects the two reciprocally closest points of the oppositely located flats. The symmetrical hole pattern allows reliable sealing of the drive flange to be achieved.

According to a preferred embodiment of the invention, the drilled holes are arranged outside, and symmetrically with respect to, the distance line and a transverse straight line running perpendicularly to same. The flange width is reduced at the flats on the drive flange. A drilled hole at such a narrow point would further reduce the width of a sealing agent so that reliable sealing could not be guaranteed. Since the drilled holes lie outside the distance line and the transverse straight line, i.e. outside the principal axes of the drive flange, an adequate width of a sealing agent can be ensured at these narrow points.

According to a preferred development of the invention, the four drilled holes arranged in one flange half are positioned such that a first drilled hole is arranged at a first angle to the distance line, a second drilled hole at a second angle to the first drilled hole, and a third drilled hole at a third angle to the second drilled hole, wherein the angles are measured as viewed from a center point of the hole circle respectively, and wherein a ratio of the first angle to the third is constant, preferably 1:2, and the sum of the three angles lies in a range from 112.5 to 118.5. This angle layout of the drilled holes creates a drive flange with a uniform hole pattern for all gear train housings, with the result that interchangeability is increased and storage simplified.

According to a preferred development of the invention, a gear train, in particular a spur-gear gear train, a bevel-gear gear train, or a flat gear train, is realized with a gear train housing from a series as claimed in one of claims 1 to 11. The inventive series of gear train housings is particularly well suited to modular geared motors.

In the following, the invention is explained on the basis of a plurality of exemplary embodiments with the aid of the enclosed drawings. These show:

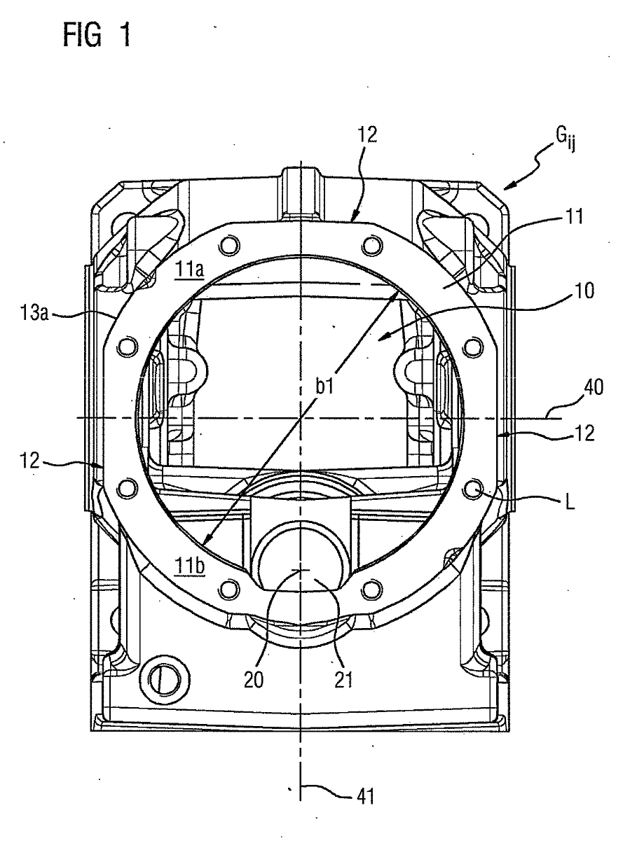

FIG. 1 a view of a gear train housing incorporating a view of a drive flange;

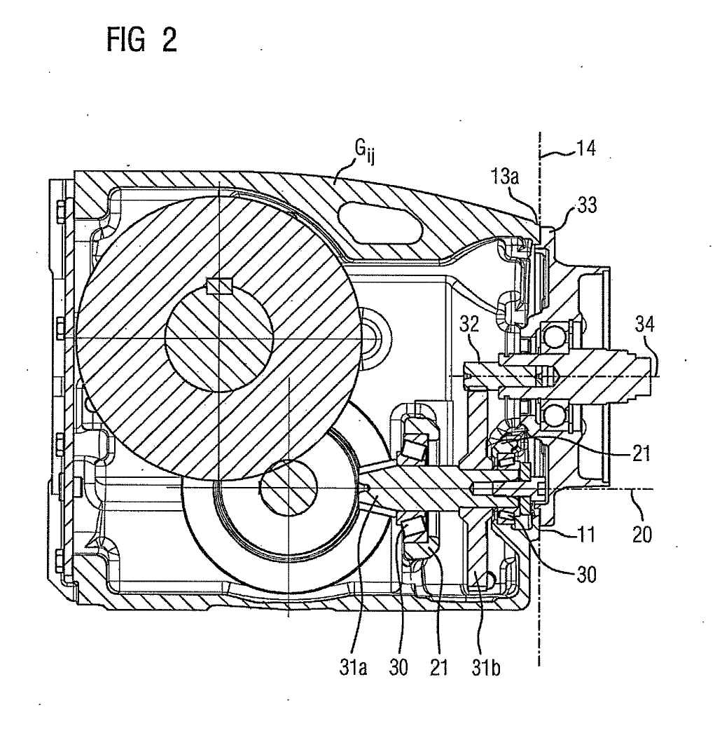

FIG. 2 a section of a gear train with the inventive gear train housing shown in FIG. 1, with the plane of the section perpendicular to the plane of a drive flange;

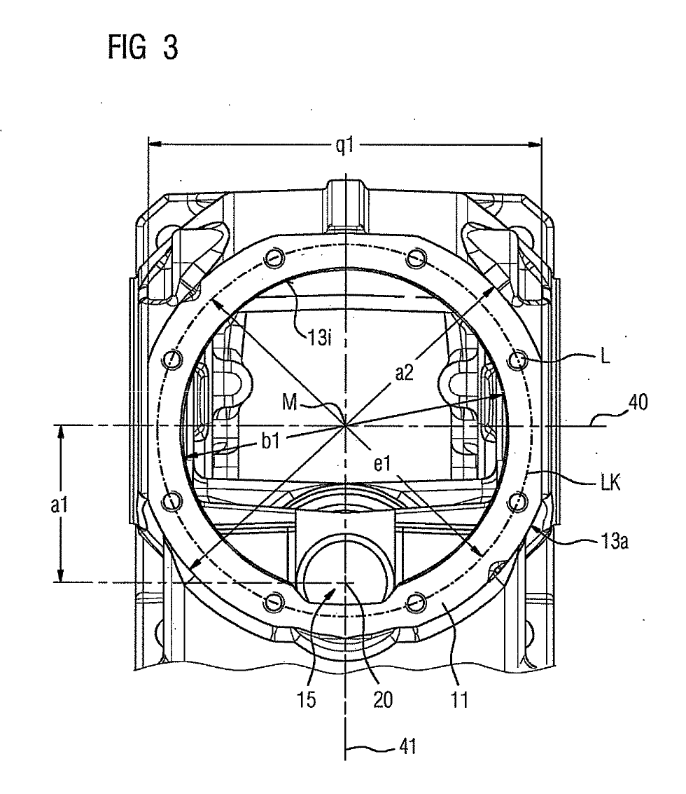

FIG. 3 a view as in FIG. 1, specifying the dimensions;

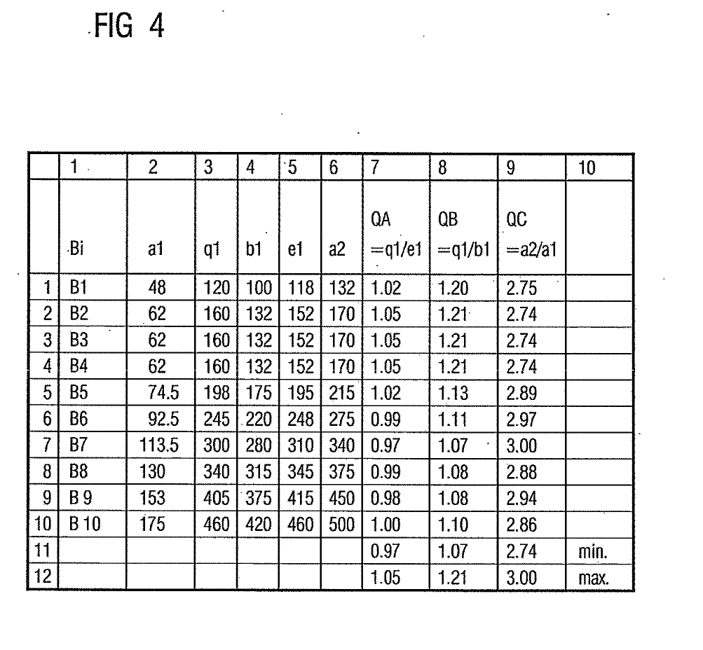

FIG. 4 a table of the dimensions;

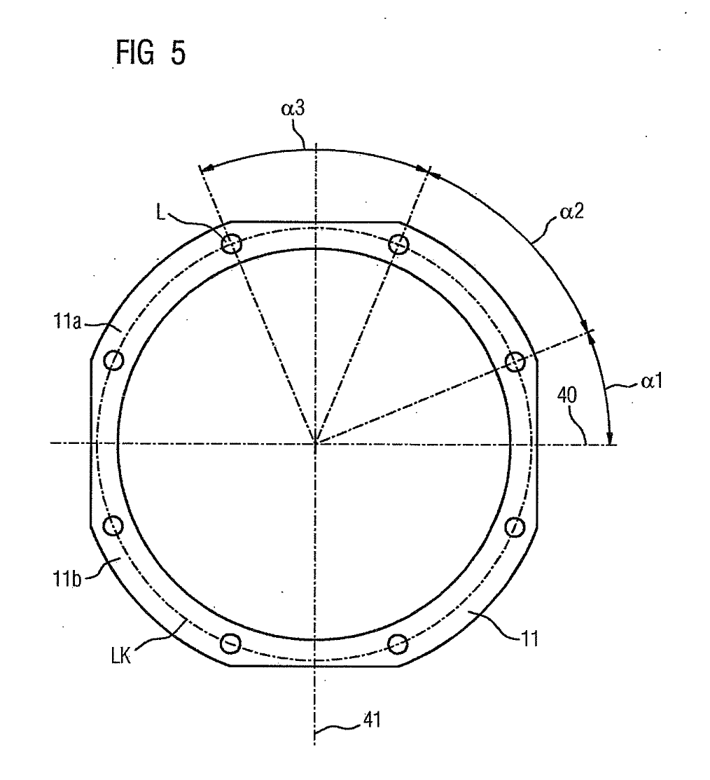

FIG. 5 a schematic view of a drive flange, specifying the angles of the drilled holes;

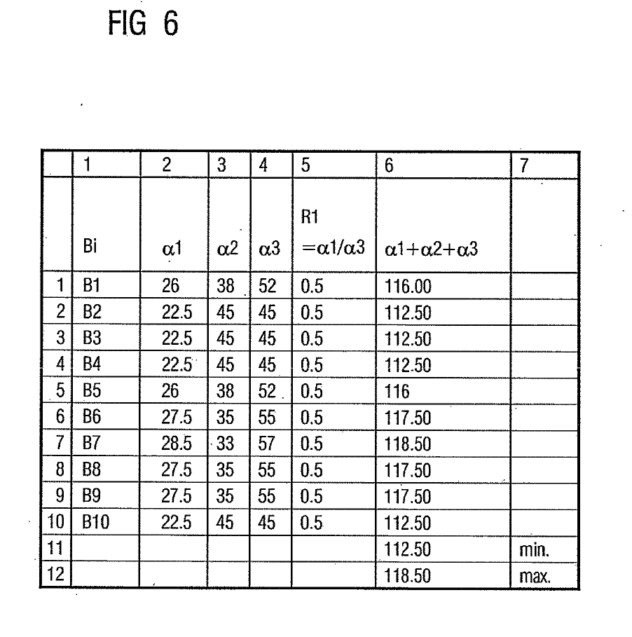

FIG. 6 a table of the angles; and

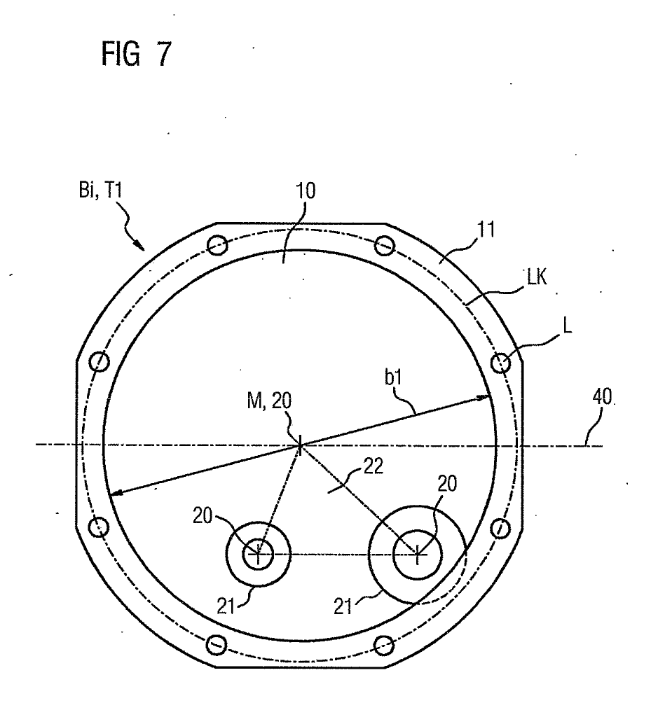

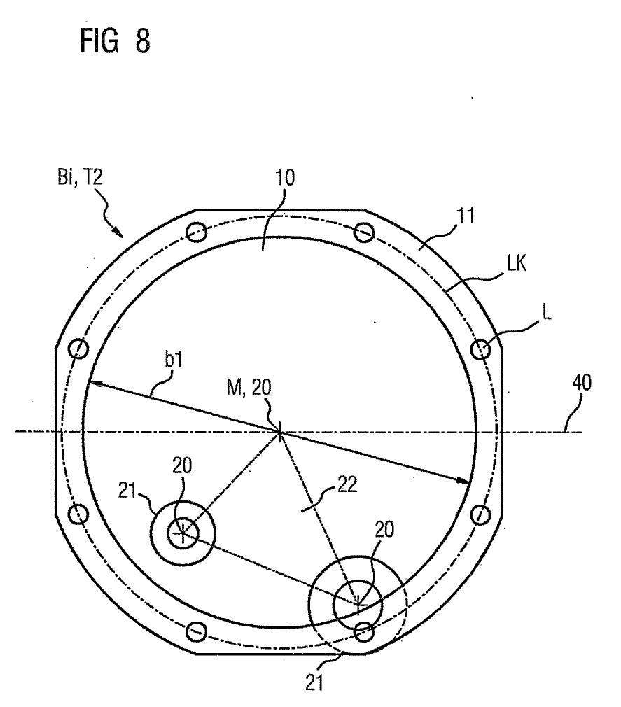

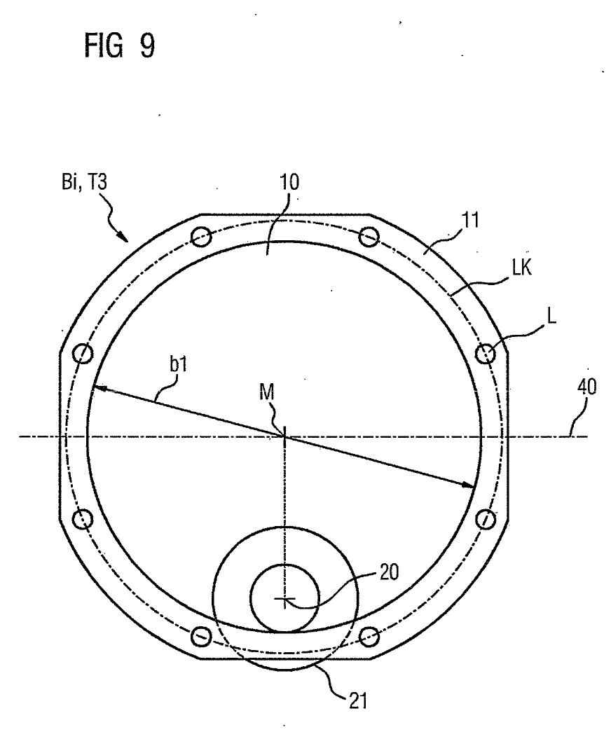

FIGS. 7-9 schematic views of a drive flange of a gear train housing, specifying bearing points for a spur-gear gear train (FIG. 7), a flat gear train (FIG. 8), and a bevel-gear gear train (FIG. 9).

FIG. 1 shows a view of a gear train housing Gij that belongs to a series of gear train housings which encompasses different sizes of the gear train housing. FIG. 2 shows a section of a bevel-gear gear train with the gear train housing Gij represented in FIG. 1, where the plane of the section runs perpendicular to the, plane 14 of the drive flange 11.

The gear train housing Gij is suitable for the bevel-gear gear train type. The gear train housing Gij has a housing opening 10 on the drive side, which is closed off by an adapter plate for attaching a motor. The axes 20 of bearing points 21 provided to accommodate shaft bearings (here: the bevel pinion shaft bearing 30) for toothed parts (here: the bevel pinion 31a and the toothed wheel 31b meshing with a drive pinion 32 of the drive stage), which axes run perpendicularly to the plane 14 of the drive flange 11, lie inside a minimum internal diameter b1 of the drive flange 11 as viewed in the direction represented in FIG. 1, i.e. perpendicular to the plane 14 of the drive flange 11.

The essentially circular drive flange 11 has flats 12 on the outer edge 13a on two oppositely located sides. Eight drilled holes L are arranged in the drive flange 11, which drilled holes lie on a hole circle LK and are provided to accommodate connecting screws. Four drilled holes L are arranged in each half 11a and 11b of the drive flange 11 as divided by a distance line 40 of the flats 12.

FIG. 3 shows the same view as in FIG. 1, with a number of dimensions that are important for the invention being additionally specified.

The figure shows the axis spacing a1 of the first gear train stage. In the case of the bevel-gear gear train represented in FIG. 2, this axis spacing a1 corresponds to the distance between the axis 34 of the drive pinion 32 and the axis 20 of the toothed wheel 31b meshing with same.

The figure additionally shows the distance q1 between the horizontally opposite flats, i.e. the length of the line that connects the two reciprocally closest points of the oppositely located flats 12 on the outer edge 13a of the drive flange 11. The distance q1 corresponds to the minimum external diameter of the drive flange 11, as measured along the distance line 40.

The figure also shows the minimum internal diameter b1 of the drive flange 11. Since the drive flange 11 has a recess 15 on its inner edge 13i in the area of the axis 20, the smallest internal diameter b1 has to be measured outside the recess 15, such as along the distance line 40.

Furthermore, the figure shows the hole circle diameter e1, i.e. the diameter of the circle LK on which the drilled holes L are arranged.

Additionally, the figure shows the maximum external diameter a2 of the drive flange 11. Since the drive flange 11 has flats 12 on its outer edge 13a in the area of the connecting line 40 and the transverse straight line 41 running at 90 degrees with respect to same, the maximum external diameter a2 has to be measured outside the flats 12, such as on the diagonal between the distance line 40 and the transverse straight line 41.

FIG. 4 reproduces a table of the dimensions a1, q1, b1, e1, and a2 (see columns 2 to 6) and also certain ratios QA, QB, and QC of these dimensions (see columns 7 to 9). The ratio QA is the ratio of the distance q1 between the horizontally opposite flats q1 to the hole circle diameter e1. The ratio QB is the ratio of the distance q1 between the horizontally opposite flats q1 to the minimum internal diameter b1 of the drive flange 11. The ratio QC is the ratio of the maximum external diameter a2 of the drive flange 11 to the axis spacing al of the first gear train stage.

The dimensions and ratios are listed for twelve different sizes Bi, as specified in column 1. The minimum and maximum values respectively of columns 7 to 9 are specified in the rows 13 and 14.

The values specified in FIG. 4 lie in value ranges selected such that the shaft bearings, shafts, and toothed parts of the gear trains are easily accessible through the housing opening. As a result, assembly and maintenance are considerably simplified.

FIG. 5 shows a schematic view of a drive flange 11 specifying the angles α1, α2, and α3 of the drilled holes L. The drilled holes L lying on the hole circle LK in one half 11a, 11b of the drive flange 11 respectively are arranged in a predetermined angle pattern.

The vertex of the angles α1, α2, and α3 of the three successive drilled holes L, called the first, second, and third drilled holes starting from the distance line 40, is the center point M of the drive flange 11. One limb of the first angle α1 is the distance line 40, the other limb runs through the axis of the first drilled hole L. One limb of the second angle α2 runs through the axis of the first drilled hole L, the other limb through the axis of the second drilled hole L. One limb of the third angle α3 runs through the axis of the second drilled hole L, the other limb through the axis of the third drilled hole L.

The fourth drilled hole L located in the half 11a of the drive flange 11 is arranged symmetrically with respect to the first drilled hole L.

FIG. 6 reproduces a table of the angles α1, α2, and α3 (see columns 2 to 4) and also a ratio R1 constructed from same (see column 5), and the sum of the three angles (see column 6). The ratio R1 is the ratio of the first angle α1 to the third angle α3. The dimensions and ratios are listed for twelve different sizes Bi, as specified in column 1. The minimum and maximum values of column 6 are specified in the rows 13 and 14.

The eight drilled holes L of the drive flange 11 are not only arranged point-symmetrically on the drive flange 11 with reference to the center point M of the drive flange 11 but also arranged symmetrically on the drive flange 11 with reference to the connecting line 40 and the transverse straight line 41. Consequently, the first angle α1 is half as large as the third angle α3, i.e. the ratio R1 comprises a constant 0.5.

The angles specified in FIG. 6 lie in value ranges selected such that a congruent hole pattern is created for all gear train housings; with the result that interchangeability is increased and storage is simplified.

FIGS. 7 to 9 show schematic views of a drive flange 11 for gear train housings of different types Tj but the same size Bi.

FIG. 7 shows a drive flange 11 of a gear train housing of the type T1: “spur-gear gear train”. The axes 20 of bearing supports 21 provided to accommodate shaft bearings for toothed parts, which axes run perpendicularly to the plane of the drive flange 11, lie inside the minimum internal diameter b1 of the drive flange 11 as viewed in a direction perpendicular to the plane of the drive flange 11. The circles drawn around the two lower axes 20 respectively specify the internal and external diameter of the bearing point 21. The bearing triangle 22 formed by the axes 20 therefore lies completely inside the housing opening 10.

FIG. 8 shows a drive flange 11 of a gear train housing of the type T2: “flat gear train”. The axes 20 of bearing supports 21 provided to accommodate shaft bearings for toothed parts, which axes run perpendicularly to the plane of the drive flange 11, lie inside the minimum internal diameter b1 of the drive flange 11 as viewed in a direction perpendicular to the plane of the drive flange 11. The circles drawn around the two lower axes 20 respectively specify the internal and external diameter of the bearing point 21. The bearing triangle 22 formed by the axes 20 therefore lies completely inside the housing opening 10.

FIG. 9 shows a drive flange 11 of a gear train housing of the type T3: “bevel-gear gear train”. The axis 20 of the bearing support 21 provided to accommodate a shaft bearing for toothed parts, which axis runs perpendicularly to the plane of the drive flange 11, lies inside the minimum internal diameter b1 of the drive flange 11 as viewed in a direction perpendicular to the plane of the drive flange 11. The two circles drawn around the lower axis 20 specify the internal and external diameter of the bearing point 21.

Although the invention has been specifically illustrated and described in detail by means of the preferred exemplary embodiments, the invention is not restricted by the disclosed examples, and other variations can be derived from this by a person skilled in the art without departing from the scope of protection of the invention.

1-10. (canceled)

11. A series of gear train housings having different sizes, each size comprising different construction types constructed for at least two different types of gear trains selected from the group consisting of spur gear train, bevel gear train, flat gear train and worm gear train, said gear trains including shaft bearings provided to accommodate toothed parts, each of the gear train housings having a gear train housing opening located at a drive side of the housing, and an essentially circular drive flange surrounding the gear train opening and configured for connection to a motor, an adapter plate or an additional gear train, said drive flange having a minimum inner diameter and a minimum external diameter and provided with flats on an outer edge on two opposite locations,
wherein an axis of a bearing point of the shaft bearings extends perpendicular to a plane of the drive flange and lies inside the minimum inner diameter of the drive flange as viewed from the direction perpendicular to the plane of the drive flange for each of at least two different sizes of housings,
wherein for a spur gear train housing a ratio of the minimum external diameter of the drive flange to the minimum internal diameter of the drive flange lies in a range from about 1.07 to about 1.21 in all gear train housing sizes.

12. The series of gear train housings of claim 11, wherein for at least two different gear train housing sizes, the axis lies inside the minimum internal diameter of the drive flange for all construction types.

13. The series of gear train housings of claim 11, wherein a ratio of a maximum external diameter of the drive flange to an axis spacing of bearing points provided to accommodate the shaft bearings for toothed parts of a first gear train stage lies in a range from approx. 2.74 to approx. 3.00 in all sizes in the case of a type suitable for a spur-gear gear train.

14. The series of gear train housings of claim 11, wherein the drive flange is provided with drill holes, which drill holes are arranged on a drill hole circle having a diameter and to accommodate connecting screws, and wherein a ratio of a minimum external diameter of the drive flange to the diameter of the hole circle is in a range from approximately 0.97 to approximately 1.05 for the spur-gear type gear train in all sizes of gear train housings.

15. The series of gear train housings of claim 11, wherein the drive flange has drilled holes provided to accommodate connecting screws, which drilled holes are arranged point-symmetrically on a hole circle having a diameter.

16. The series of gear train housings of claim 15, wherein the hole circle extends uninterruptedly on the drive flange over an entire periphery of the drive flange.

17. The series of gear train housings as in claim 15, wherein the fiats located on two oppositely located sides of the essentially circular drive flange are positioned on an outer edge of the drive flange, and wherein eight drilled holes are arranged in the drive flange, wherein four drilled holes are arranged in each half of the drive flange as divided by a distance line between the flats.

18. The series of gear train housings of claim 17, wherein the drilled holes are arranged outside, and symmetrically with respect to a vertical distance line and a transverse straight line running perpendicularly to the vertical distance line.

19. The series of gear train housings of claim 17, wherein the four drilled holes arranged in one flange half are positioned such that a first drilled hole is arranged at a first angle to the vertical distance line, a second drilled hole at a second angle to the first drilled hole and a third drilled hole at a third angle to the second drilled hole, wherein the angles are measured as viewed from a center point of the hole circle respectively, and wherein a ratio of the first angle to the third angle is constant, and the sum of the three angles lies in a range from 112.5 to 118.5.

20. The series of gear train housings of claim 19, wherein the range is 1:2.

21. A gear train, comprising a gear train housing from a series of gear train housings having different sizes, each size comprising different construction types constructed for at least two different types of gear trains selected from the group consisting of spur gear train, bevel gear train, flat gear train and worm gear train, said gear trains including shaft bearings provided to accommodate toothed parts, each of the gear train housings having a gear train housing opening located at a drive side of the housing, and an essentially circular drive flange surrounding the gear train opening and configured for connection to a motor, an adapter plate or an additional gear train, said drive flange having a minimum inner diameter and a minimum external diameter and provided with flats on an outer edge on two opposite locations, wherein an axis of a bearing point of the shaft bearings extends perpendicular to a plane of the drive flange and lies inside the minimum inner diameter of the drive flange as viewed from the direction perpendicular to the plane of the drive flange for each of at least two different sizes of housings, wherein for a spur gear train housing a ratio of the minimum external diameter of the drive flange to the minimum internal diameter of the drive flange lies in a range from about 1.07 to about 1.21 in all gear train housing sizes.

22. The gear train of claim 21, constructed in the form of a spur-gear gear train, bevel-gear gear train, flat gear train, or worm gear train.

23. The gear train of claim 21, wherein for at least two different gear train housing sizes, the axis lies inside the minimum internal diameter of the drive flange for all construction types.

24. The gear train of claim 21, wherein a ratio of a maximum external diameter of the drive flange to an axis spacing of bearing points provided to accommodate the shaft bearings for toothed parts of a first gear train stage lies in a range from approx. 2.74 to approx. 3.00 in all sizes in the case of a type suitable for a spur-gear gear train.

25. The gear train of claim 21, wherein the drive flange is provided with drill holes, which drill holes are arranged on a drill hole circle having a diameter and to accommodate connecting screws, and wherein a ratio of a minimum external diameter of the drive flange to the diameter of the hole circle is in a range from approximately 0.97 to approximately 1.05 for the spur-gear type gear train in all sizes of gear train housings.

26. The gear train of claim 21, wherein the drive flange has drilled holes provided to accommodate connecting screws, which drilled holes are arranged point-symmetrically on a hole circle having a diameter.

27. The gear train of claim 26, wherein the hole circle extends uninterruptedly on the drive flange over an entire periphery of the drive flange.

28. The gear train as in claim 26, wherein the flats located on two oppositely located sides of the essentially circular drive flange are positioned on an outer edge of the drive flange, and wherein eight drilled holes are arranged in the drive flange, wherein four drilled holes are arranged in each half of the drive flange as divided by a distance line between the flats.

29. The gear train of claim 28, wherein the drilled holes are arranged outside, and symmetrically with respect to a vertical distance line and a transverse straight line running perpendicularly to the vertical distance line.

30. The gear train of claim 28, wherein the four drilled holes arranged in one flange half are positioned such that a first drilled hole is arranged at a first angle to the vertical distance line, a second drilled hole at a second angle to the first drilled hole and a third drilled hole at a third angle to the second drilled hole, wherein the angles are measured as viewed from a center point of the hole circle respectively, and wherein a ratio of, the first angle to the third angle is constant, and the sum of the three angles lies in a range from 212.5 to 218.5.

31. The gear train of claim 30, wherein the range is 1:2.
